(19) United States
(12) Patent Application Publication
(10) Pub. No.: US 2017/0222410 A1
(43) Pub. Date: Aug. 3, 2017

(54) Wire Stripping Machine

(71) Applicant: Billy R. Alexander, Weatherford, TX (US)

(72) Inventor: Billy R. Alexander, Weatherford, TX (US)

(21) Appl. No.: 15/210,061

(22) Filed: Jul. 14, 2016

Related U.S. Application Data
(60) Provisional application No. 62/288,009, filed on Jan. 28, 2016.

(51) Int. Cl. H02G 1/12

(52) U.S. Cl. CPC H02G 1/1265

(57) ABSTRACT

A wire stripping machine is utilized to cut and remove the insulation material from an electrical wire. A first roller blade and a second roller blade are rotatably mounted within an enclosure. An electrical wire may be fed in between the first roller blade and the second roller blade in order to cut and remove the insulation material from the electrical wire. The first roller blade is rotated by a drive assembly including a first drive gear and a motor. The first drive gear is connected to a second drive gear and the second roller blade by a chain that allows the second roller blade to rotate along with the first roller blade. The position of the second roller blade relative to the first roller blade may be adjusted in order to accommodate electrical wires of varying diameters.

The current application claims a priority to the U.S. Provisional Patent application Ser. No. 62/288,009 filed on Jan. 28, 2016.

### FIELD OF THE INVENTION

The present invention relates generally to an apparatus for removing the insulation from a wire. More specifically, the present invention is a wire stripping machine that is utilized to cut and remove the insulation from an electrical wire.

### BACKGROUND OF THE INVENTION

Electrical wires are utilized for a wide variety of purposes. Conventional electrical wires are sheathed in an insulation material such as silicone rubber or ethylene propylene diene monomer (EPDM) rubber. Insulation generally serves to restrict the flow of electric current in order to greatly reduce the possibility of conducting electricity under the influence of an electric field. Electrical wires are often recycled after use with the removal of the insulation on the wires a common step of the recycling process. The insulation removal process can be both time-consuming and costly. A common means of removing the insulation is by melting the insulation material off of the metal core of the electrical wire. However, this method generally requires a substantial energy investment and carries negative environmental effects as well. As a result, a convenient and straightforward means of removing insulation material from an electrical wire is desirable.

The present invention is a wire stripping machine that is utilized to cut and remove the insulation from an electrical wire without significant energy investment or effort. The present invention is adjustable in order to accommodate electrical wires of varying diameters. The present invention utilizes a dual roller system for cutting the electrical wires. Electrical wires may be fed in between the dual rollers in order to cut and remove the insulation from the electrical wires.

### BRIEF DESCRIPTION OF THE DRAWINGS

FIG. 1 is a perspective view of the present invention.

FIG. 2 is an exploded perspective view of the present invention.

FIG. 3 is an alternate perspective view of the present invention.

FIG. 4 is a side view of the present invention.

FIG. 5 is a cross-sectional view of the present invention taken along line A-A of FIG. 4.

FIG. 6 is a diagram detailing the electrical connections of the present invention.

### DETAIL DESCRIPTIONS OF THE INVENTION

All illustrations of the drawings are for the purpose of describing selected versions of the present invention and are not intended to limit the scope of the present invention.

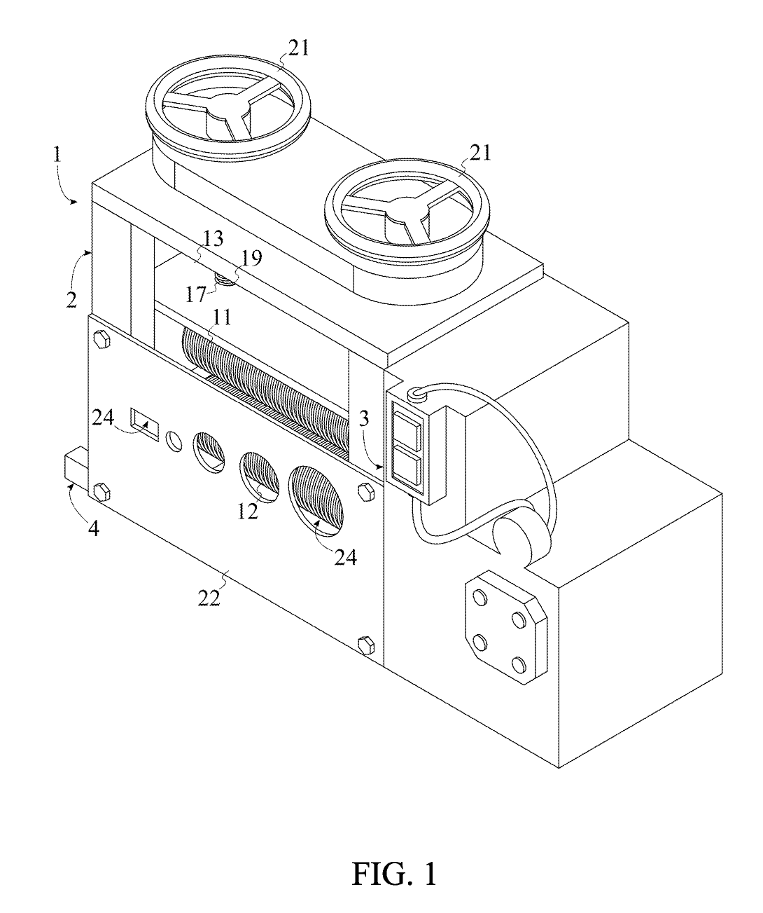

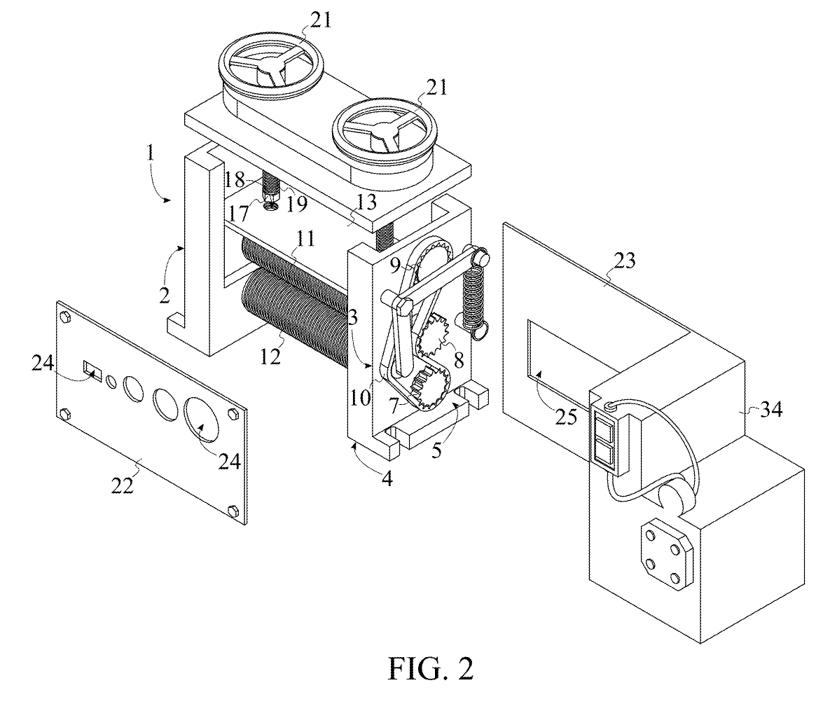

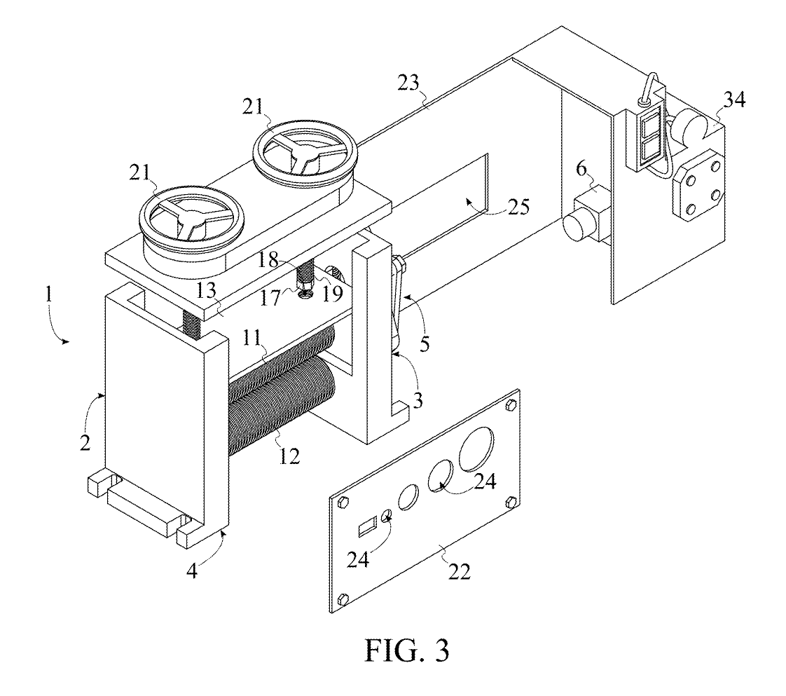

The present invention is a wire stripping machine for cutting and removing the insulation material from an electrical wire. The present invention is shown in FIGS. 1-5 and comprises an enclosure 1, a first roller blade 11, a second roller blade 12, a drive assembly 5, and an adjustment plate 13.

The enclosure 1 serves as a housing into and onto which other components of the present invention are mounted and connected. The enclosure 1 comprises a first side 2 and a second side 3 that serve as opposing sides of the enclosure 1. The first roller blade 11 and the second roller blade 12 are utilized to physically cut and remove the insulation material from an electrical wire. The first roller blade 11 and the second roller blade 12 each include one or more sharpened cutting edges for cutting into the insulation material. The first roller blade 11 and the second roller blade 12 are rotatably mounted in between the first side 2 and the second side 3. The rotational motion of the first roller blade 11 and the second roller blade 12 serves to draw the electrical wire in between the first roller blade 11 and the second roller blade 12 as well as to remove the insulation material after the insulation material has been cut. The first side 2 and the second side 3 are positioned parallel to each other, forming two side walls of the enclosure 1. The first roller blade 11 and the second roller blade 12 are oriented parallel to each other, enabling an electrical wire to be easily inserted in between the first roller blade 11 and the second roller blade 12 for removal of the insulation material.

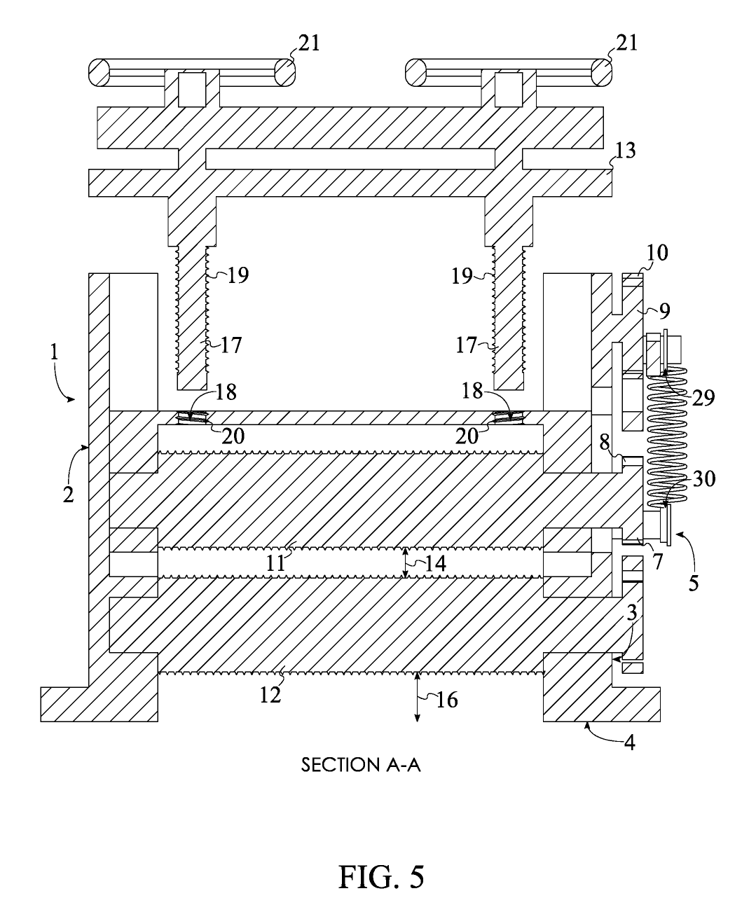

In the preferred embodiment of the present invention, the drive assembly 5 provides rotational force to the first roller blade 11 and the second roller blade 12 and additionally allows the position of the second roller blade 12 to be adjusted relative to the first roller blade 11. This enables the present invention to accommodate electrical wires of varying diameters. The first roller blade 11 and the second roller blade 12 are torsionally connected to the drive assembly 5. The drive assembly 5 is thus able to rotate both the first roller blade 11 and the second roller blade 12 in order to cut and remove the insulation material from an electrical wire. The first roller blade 11 and the second roller blade 12 are offset from each other by an adjustable distance 14 as shown in FIG. 5. The adjustable distance 14 may be widened or narrowed based on the requirements of removing the insulation material from a specific electrical wire.

The adjustment plate 13 is utilized when adjusting the position of the second roller blade 12 with respect to the first roller blade 11. The second roller blade 12 is longitudinally and rotatably mounted to the adjustment plate 13, enabling the second roller blade 12 to rotate while remaining in contact with the adjustment plate 13. As a result, the adjustment plate 13 does not hinder the ability of the second roller blade 12 to rotate. The adjustment plate 13 is slidably mounted in between the first side 2 and the second side 3. In the preferred embodiment of the present invention, this allows the adjustment plate 13 to slide in an upward and downward direction within the enclosure 1 when adjusting the position of the second roller blade 12 with respect to the first roller blade 11.

The present invention further comprises an adjustment slot 15. The adjustment slot 15 is an opening within the enclosure 1 that is able to accommodate the second roller blade 12 and enables the second roller blade 12 to slide within the enclosure 1 when the position of the second roller blade 12 is being adjusted. The adjustment slot 15 traverses through the second side 3, adjacent to the second roller blade 12, forming an opening in the second side 3 for the second roller blade 12. The second roller blade 12 is slidably engaged within the adjustment slot 15. In the preferred embodiment of the present invention, the adjustment slot 15 is oriented in a manner such that the second roller blade 12 is able to slide in an upward and downward direction when adjusting the position of the second roller blade 12 with respect to the first roller blade 11. The first roller blade 11 is offset from a base 4 of the enclosure 1 by a fixed distance 16 as shown in FIG. 5. In this configuration of the present invention, the position of the first roller blade 11 is not adjustable as with the second roller blade 12. However, the first roller blade 11 remains able to rotate.

The present invention further comprises at least one adjustment member 17, at least one mounting hole 18, a male threading 19, and a female threading 20. In the preferred embodiment of the present invention, the at least one adjustment member 17 is utilized when moving the adjustment plate 13 and the attached second roller blade 12 in an upward and downward direction. The at least one mounting hole 18 is able to accommodate the at least one adjustment member 17 and allows the at least one adjustment member 17 to be connected to the adjustment plate 13. The male threading 19 and the female threading 20 enable rotational motion of the at least one adjustment member 17 to move the adjustment plate 13 and the second roller blade 12 in an upward and downward direction based on the direction of rotation. The at least one mounting hole 18 traverses normally through the adjustment plate 13, forming an opening within the adjustment plate 13. The at least one adjustment member 17 is rotatably and normally connected through the at least one mounting hole 18. The at least one adjustment member 17 is thus positioned through the adjustment plate 13 and is able to rotate in order to move the adjustment plate 13 upward and downward along the at least one adjustment member 17. The at least one adjustment member 17 is rotatably and laterally mounted into the second roller blade 12. As a result, rotating the at least one adjustment member 17 enables the second roller blade 12 to move upward and downward along with the adjustment plate 13. The male threading 19 is helically connected around the at least one adjustment member 17 while the female threading 20 is helically connected within the at least one mounting hole 18. As a result, the at least one adjustment member 17 is able to rotate while engaged within the at least one mounting hole 18. The male threading 19 is engaged to the female threading 20 to allow the at least one adjustment member 17 to be rotated to move the adjustment plate 13 and the second roller blade 12 upward and downward.

The present invention further comprises at least one user input handle 21. The at least one user input handle 21 serves as a physical input that allows the user to rotate the at least one adjustment member 17 when adjusting the position of the second roller blade 12. In the preferred embodiment of the present invention, the at least one user input handle 21 is a wheel that is turned when adjusting the position of the second roller blade 12. The at least one user input handle 21 is torsionally connected to the at least one adjustment member 17, opposite to the second roller blade 12. As a result, turning the at least one user input handle 21 allows the at least one adjustment member 17 to turn as well.

The present invention further comprises a front cover plate 22, a rear cover plate 23, at least one wire feed port 24, and an exit port 25. The front cover plate 22 and the rear cover plate 23 provide physical coverage for the first roller blade 11 and the second roller blade 12 within the enclosure 1. The at least one wire feed port 24 is utilized when feeding an electrical wire into the enclosure 1 and in between the first roller blade 11 and the second roller blade 12. The at least one wire feed port 24 may be of multiple sizes in order to accommodate varying diameters of electrical wires. Electrical wires that have been stripped of insulation material are able to exit the enclosure 1 through the exit port 25. The front cover plate 22 is externally and removably mounted to the enclosure 1 from the first side 2 to the second side 3, covering the first roller blade 11 and the second roller blade 12 while allowing the front cover plate 22 to be easily removed from the enclosure 1. Similarly, the rear cover plate 23 is externally and removably mounted to the enclosure 1 from the first side 2 to the second side 3, opposite to the front cover plate 22. The rear cover plate 23 is thus able to cover the first roller blade 11 and the second roller blade 12 while remaining easily removable from the enclosure 1. The at least one wire feed port 24 traverses normally through the front cover plate 22, forming an opening through which an electrical wire may be fed. The exit port 25 traverses normally through the rear cover plate 23, forming an opening through which a stripped electrical wire is able to exit the enclosure 1.

Again with reference to FIGS. 1-5, the drive assembly 5 comprises a motor 6, a first drive gear 7, a second drive gear 8, an idler gear 9, and a chain 10. The motor 6 provides rotational force to the first drive gear 7 and the first roller blade 11, allowing the first roller blade 11 to rotate. The second drive gear 8 and the chain 10 enable the second roller blade 12 to rotate along with the first roller blade 11 based on rotational force provided by the motor 6. The idler gear 9 serves to provide tension to the chain 10 while allowing the first drive gear 7 and the second drive gear 8 to rotate. The motor 6 is torsionally connected to the first drive gear 7, enabling rotational force from the motor 6 to be transmitted to the first drive gear 7. The first drive gear 7 is rotatably connected to the second side 3 and is torsionally connected to the first roller blade 11. As a result, rotational force from the motor 6 is transmitted to the first drive gear 7 and to the first roller blade 11, allowing the first roller blade 11 to rotate. The second drive gear 8 is rotatably connected to the second side 3 and is torsionally connected to the second roller blade 12, allowing rotation of the second drive gear 8 to rotate the second roller blade 12 as well. The idler gear 9 is rotatably connected to the second side 3 and may thus rotate without impedance based on the movement of the chain 10. The first drive gear 7 and the second drive gear 8 are offset from each other across the second side 3. As a result, the first drive gear 7 and the second drive gear 8 are positioned relative to each other with respect to the positioning of the first roller blade 11 and the second roller blade 12. The second drive gear 8 is additionally able to move along with the second roller blade 12 during adjustment of the position of the second roller blade 12 with respect to the first roller blade 11. The chain 10 is engaged about the first drive gear 7 and about the idler gear 9, allowing the rotation of the first drive gear 7 to rotate the idler gear 9 as well. The second drive gear 8 is engaged to the chain 10 in between the first drive gear 7 and the second drive gear 8. As a result, the second drive gear 8 is able to rotate based on the rotation of the first drive gear 7 as well. The first drive gear 7 is torsionally coupled to the second drive gear 8 through the chain 10, enabling both the first roller blade 11 and the second roller blade 12 to rotate during use of the present invention.

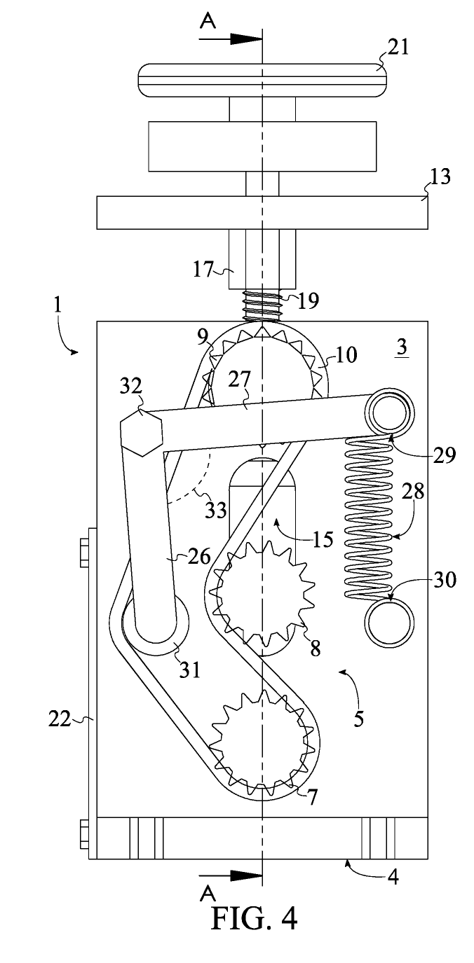

With reference to FIG. 4, the present invention further comprises an idler arm 26, a leveraging arm 27, a tension spring 28, a roller 31, and a pivot base 32. The idler arm 26 and the leveraging arm 27 are utilized to adjust the positioning of the roller 31 in order to maintain tension of the chain 10 when the position of the second roller blade 12 is adjusted. The roller 31 is able to move along the second side 3 while remaining in contact with the chain 10 in order to maintain tension in the chain 10. The pivot base 32 enables the positioning of the idler arm 26 and the leveraging arm 27 to be adjusted through a pivoting motion about the pivot base 32. The tension spring 28 is utilized in conjunction with the idler arm 26, the leveraging arm 27, and the roller 31 to maintain tension in the chain 10 when the position of the second roller blade 12 is adjusted. The idler arm 26 is terminally connected to the pivot base 32 while the leveraging arm 27 is terminally connected to the pivot base 32 as well. The idler arm 26 and the leveraging arm 27 are thus able to pivot about the pivot base 32. The idler arm 26 and the leveraging arm 27 are positioned at an optimal angle 33 to each other. The optimal angle 33 is the angle at which the idler arm 26 and the leveraging arm 27 are oriented relative to each other that allows the idler arm 26 and the leveraging arm 27 to move and position the roller 31 to maintain tension in the chain 10. The pivot base 32 is rotatably connected to the second side 3 to allow the idler arm 26 and the leveraging arm 27 to rotate about the pivot base 32. The roller 31 is rotatably and terminally connected to the idler arm 26, opposite to the pivot base 32. The roller 31 is thus able to roll based on the movement of the chain 10 as the roller 31 is moved by the idler arm 26. The chain 10 is laterally engaged against the roller 31, providing a point of contact on the chain 10 through which the roller 31 is able to maintain the tension in the chain 10. A first end 29 of the tension spring 28 is terminally connected to the leveraging arm 27, opposite to the pivot base 32. A second end 30 of the tension spring 28 is fixed to the second side 3. The leveraging arm 27 is thus able to expand and compress the tension spring 28 as needed when adjusting the position of the second roller blade 12 in order to maintain tension in the chain 10. The second end 30 remains fixed in place in order to allow the tension spring 28 to be expanded and compressed.

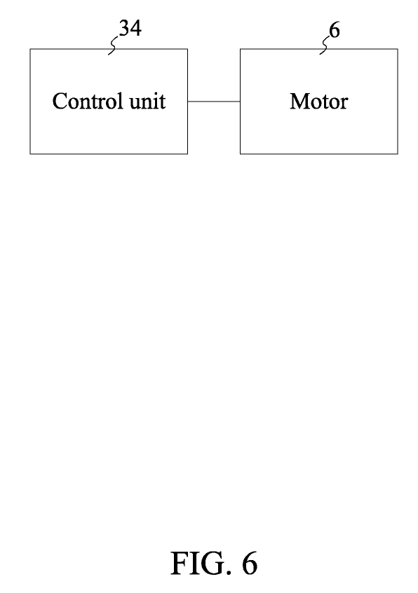

With continued reference to FIGS. 1-5 and with reference to FIG. 6, the present invention further comprises a control unit 34 that allows the user to input commands as well as manage the present invention. The control unit 34 is externally mounted to the enclosure 1 to provide user access from the exterior of the present invention. The control unit 34 is electronically connected to the motor 6, allowing the user to activate and deactivate the motor 6 when utilizing the present invention. In the preferred embodiment of the present invention, the rear cover plate 23 is adjacently connected to the control unit 34 and may be removed from the enclosure 1 along with the control unit 34.

Although the present invention has been explained in relation to its preferred embodiment, it is understood that many other possible modifications and variations can be made without departing from the spirit and scope of the present invention as hereinafter claimed.

What is claimed is:

1. A wire stripping machine comprises:
an enclosure;
a first roller blade;
a second roller blade;
a drive assembly;
an adjustment plate;
the enclosure comprises a first side and a second side;
the first roller blade and the second roller blade being rotatably mounted in between the first side and the second side;
the first side and the second side being positioned parallel to each other;
the first roller blade and the second roller blade being oriented parallel to each other;
the first roller blade and the second roller blade being torsionally connected to the drive assembly;
the first roller blade and the second roller blade being offset from each other by an adjustable distance;
the second roller blade being longitudinally and rotatably mounted to the adjustment plate; and
the adjustment plate being slidably mounted in between the first side and the second side.

2. The wire stripping machine as claimed in claim 1 further comprises:
an adjustment slot;
the adjustment slot traversing through the second side, adjacent to the second roller blade;
the second roller blade being slidably engaged within the adjustment slot; and
the first roller blade being offset from a base of the enclosure by a fixed distance.

3. The wire stripping machine as claimed in claim 1 further comprises:
at least one adjustment member;
at least one mounting hole;
a male threading;
a female threading;
the at least one mounting hole traversing normally through the adjustment plate;
the at least one adjustment member being rotatably and normally connected through the at least one mounting hole;
the at least one adjustment member being rotatably and laterally mounted into the second roller blade;
the male threading being helically connected around the at least one adjustment member;
the female threading being helically connected within the at least one mounting hole; and
the male threading being engaged to the female threading.

4. The wire stripping machine as claimed in claim 3 further comprises:
at least one user input handle; and
the at least one user input handle being torsionally connected to the at least one adjustment member, opposite to the second roller blade.

5. The wire stripping machine as claimed in claim 1 further comprises:
a front cover plate;
a rear cover plate;
at least one wire feed port;
an exit port;
the front cover plate being externally and removably mounted to the enclosure from the first side to the second side;
the rear cover plate being externally and removably mounted to the enclosure from the first side to the second side, opposite to the front cover plate;
the at least one wire feed port traversing normally through the front cover plate; and
the exit port traversing normally through the rear cover plate.

6. The wire stripping machine as claimed in claim 1 further comprises:
the drive assembly comprises a motor, a first drive gear, a second drive gear, an idler gear, and a chain;
the motor being torsionally connected to the first drive gear;
the first drive gear being rotatably connected to the second side;
the first drive gear being torsionally connected to the first roller blade;
the second drive gear being rotatably connected to the second side;
the second drive gear being torsionally connected to the second roller blade;
the idler gear being rotatably connected to the second side;
the first drive gear and the idler gear being offset from each other across the second side;
the chain being engaged about the first drive gear and about the idler gear;
the second drive gear being engaged to the chain in between the first drive gear and the second drive gear; and
the first drive gear being torsionally coupled to the second drive gear through the chain.

7. The wire stripping machine as claimed in claim 6 further comprises:
an idler arm;
a leveraging arm;
a tension spring;
a roller;
a pivot base;
the idler arm being terminally connected to the pivot base;
the leveraging arm being terminally connected to the pivot base;
the idler arm and the leveraging arm being positioned at an optimal angle to each other;
the pivot base being rotatably connected to the second side;
the roller being rotatably and terminally connected to the idler arm, opposite to the pivot base;
the chain being laterally engaged against the roller;
a first end of the tension spring being terminally connected to the leveraging arm, opposite to the pivot base; and
a second end of the tension spring being fixed to the second side.

8. The wire stripping machine as claimed in claim 1 further comprises:
a control unit;
the control unit being externally mounted to the enclosure; and
the control unit being electronically connected to the motor.

9. The wire stripping machine as claimed in claim 8 further comprises:
a rear cover plate; and
the rear cover plate being adjacently connected to the control unit.

10. A wire stripping machine comprises:
an enclosure;
a first roller blade;
a second roller blade;
a drive assembly;
an adjustment plate;
an adjustment slot;
the enclosure comprises a first side and a second side;
the first roller blade and the second roller blade being rotatably mounted in between the first side and the second side;
the first side and the second side being positioned parallel to each other;
the first roller blade and the second roller blade being oriented parallel to each other;
the first roller blade and the second roller blade being torsionally connected to the drive assembly;
the first roller blade and the second roller blade being offset from each other by an adjustable distance;
the second roller blade being longitudinally and rotatably mounted to the adjustment plate;
the adjustment plate being slidably mounted in between the first side and the second side;
the adjustment slot traversing through the second side, adjacent to the second roller blade;
the second roller blade being slidably engaged within the adjustment slot; and
the first roller blade being offset from a base of the enclosure by a fixed distance.

11. The wire stripping machine as claimed in claim 10 further comprises:
at least one adjustment member;
at least one mounting hole;
a male threading;
a female threading;
the at least one mounting hole traversing normally through the adjustment plate;
the at least one adjustment member being rotatably and normally connected through the at least one mounting hole;
the at least one adjustment member being rotatably and laterally mounted into the second roller blade;
the male threading being helically connected around the at least one adjustment member;
the female threading being helically connected within the at least one mounting hole; and
the male threading being engaged to the female threading.

12. The wire stripping machine as claimed in claim 11 further comprises:
at least one user input handle; and
the at least one user input handle being torsionally connected to the at least one adjustment member, opposite to the second roller blade.

13. The wire stripping machine as claimed in claim 10 further comprises:
a front cover plate;
a rear cover plate;
at least one wire feed port;
an exit port;
the front cover plate being externally and removably mounted to the enclosure from the first side to the second side;
the rear cover plate being externally and removably mounted to the enclosure from the first side to the second side, opposite to the front cover plate;
the at least one wire feed port traversing normally through the front cover plate; and
the exit port traversing normally through the rear cover plate.

14. The wire stripping machine as claimed in claim 10 further comprises:
the drive assembly comprises a motor, a first drive gear, a second drive gear, an idler gear, and a chain;
the motor being torsionally connected to the first drive gear;
the first drive gear being rotatably connected to the second side;
the first drive gear being torsionally connected to the first roller blade;
the second drive gear being rotatably connected to the second side;
the second drive gear being torsionally connected to the second roller blade;
the idler gear being rotatably connected to the second side;
the first drive gear and the idler gear being offset from each other across the second side;
the chain being engaged about the first drive gear and about the idler gear;
the second drive gear being engaged to the chain in between the first drive gear and the second drive gear; and
the first drive gear being torsionally coupled to the second drive gear through the chain.

15. The wire stripping machine as claimed in claim 14 further comprises:
an idler arm;
a leveraging arm;
a tension spring;
a roller;
a pivot base;
the idler arm being terminally connected to the pivot base;
the leveraging arm being terminally connected to the pivot base;
the idler arm and the leveraging arm being positioned at an optimal angle to each other;
the pivot base being rotatably connected to the second side;
the roller being rotatably and terminally connected to the idler arm, opposite to the pivot base;
the chain being laterally engaged against the roller;
a first end of the tension spring being terminally connected to the leveraging arm, opposite to the pivot base; and
a second end of the tension spring being fixed to the second side.

16. The wire stripping machine as claimed in claim 10 further comprises:
a control unit;
the control unit being externally mounted to the enclosure; and
the control unit being electronically connected to the motor.

17. The wire stripping machine as claimed in claim 16 further comprises:
a rear cover plate; and
the rear cover plate being adjacently connected to the control unit.
